(19) United States
(12) Patent Application Publication
(10) Pub. No.: US 2021/0359870 A1
(43) Pub. Date: Nov. 18, 2021

(54) PRINTED MARKING FOR AN AUTHENTICATION METHOD, AND METHOD OF PRINTING AND OF AUTHENTICATING A PRINTED MARKING

(71) Applicant: NOVATEC, Montauban (FR)

(72) Inventors: Franck BOURRIERES, Montauban (FR); Francis BOURRIERES, Montauban (FR); Florian ANDRE, Corbarieu (FR); François CARABIN, Montauban (FR); Clément KAISER, Montauban (FR)

(21) Appl. No.: 17/284,961

(22) PCT Filed: Oct. 15, 2019
(86) PCT No.: PCT/EP2019/077968

§ 371 Date: Apr. 13, 2021

(30) Foreign Application Priority Data
Oct. 18, 2018 (FR) 1859633

(51) Int. Cl. H04L 9/38; H04L 9/08; H04L 9/00; G06K 19/06

(52) U.S. Cl. CPC H04L 9/38; H04L 9/0869; H04L 2209/12; G06K 19/06037; H04L 2209/608; H04L 9/001

(57) ABSTRACT

A method of printing and of authenticating a marking, having a visible printed anti-copy pattern produced by pseudorandom noise that is generated on the basis of a secret generation key, includes processing at least one image of the printed anti-copy pattern. The anti-copy pattern is printed onto a marking substrate using predetermined printing conditions. The phase of marking control involves: regenerating the pseudorandom noise on the basis of the secret generation key; creating, computationally, a digital file of an image of a simulated printed anti-copy pattern which corresponding to a projected printing quality of the regenerated pseudorandom noise; capturing at least one image of the printed anti-copy pattern; and comparing the captured image of the printed anti-copy pattern with the image of the simulated anti-copy pattern in order to determine, computationally, a mathematical distance between the image of the printed anti-copy pattern and the image of the simulated anti-copy pattern.

### CROSS REFERENCE TO RELATED APPLICATIONS

This application is a National Stage of International Application No. PCT/EP2019/077968, having an International Filing Date of 15 Oct. 2019, which designated the United States of America, and which International Application was published under PCT Article 21(2) as WO Publication No. 2020/078998 A1, which claims priority from and the benefit of French Patent Application No. 1859633, filed on 18 Oct. 2018, the disclosures of which are incorporated herein by reference in their entireties.

### 1. FIELD

The disclosure belongs to the field of printing and authentication of products by printed markings intended for identification and/or authentication of products or documents.

The disclosure concerns, in particular, a printed marking, for example in the form of a label, on any medium for which attempts at reproduction are detectable although this marking can be observed with all its graphic details. It is understood that the marking according to the present disclosure can also be printed directly on a document or a product.

In a non-limiting manner, the term “label” will be used by way of example in order to designate a marking.

The term “product” will be used in a generic manner in order to designate all types of products, such as, in a non-limiting manner, devices, packaging, information sheets, guarantee documents and administrative documents.

More particularly, the disclosure relates to a method for printing a marking using conventional printing equipment and with which a method is associated for reading a printed marking which makes it possible to check whether the printed marking was generated, or not, by the printing method, the costs, both for producing the markings as well as for control of their authenticity, being moderate. In a non-limiting manner, the printing equipment used in the present disclosure can be digital presses, laser printers, ink-jet printers, thermal printers, offset presses, flexographic equipment, etc.

### 2. BRIEF DESCRIPTION OF RELATED DEVELOPMENTS

The marking of products, for example with labels that are printed and affixed on the products or their packaging, or by direct printing on documents, is an old solution which is not very expensive due to the technical performance of printing machines and machines for the application of labels, and is practical since it is easily readable and thus allows easy identification of the product or document and its origin.

Very early in history, it was observed that adulterated products have been marked with reproduced labels or labels which were authentic but affixed to non-authentic products. Similarly, documents are sometimes falsified.

Product manufacturers and administrations producing documents have therefore sought solutions for making printed markings more difficult to reproduce and more difficult to reuse.

In order to make the reproduction of a marking more difficult, it is known to use printing media incorporating particular visually observable patterns, such as holograms, or components that can be read electronically, for example radiofrequency chips. However, the use of such special devices significantly increases the complexity and cost of the marking, and the reproduction of holograms or of radiofrequency chips is not technically of a sufficient complexity to prevent counterfeiting.

In order to prevent re-use, it is known to use glues and/or precuts which make it very difficult, or even impossible, to separate the label from its support without destroying it. However, this solution must be combined with non-reproducible forms, otherwise the counterfeiter will simply affix labels that are reproductions of authentic labels.

Another solution consists in printing the marking on a unique and non-reproducible medium, for example on a medium which incorporates, in its mass, patterns resulting from a chaotic formation process, and recording these labels in a communicating database in order to carry out authenticity controls. Patent application FR 2860670 gives an example of such supports.

This solution is particularly effective, but uses printing media manufactured and prepared for this purpose, and needs to connect to a database in order to check the authenticity of the marking. This type of authentication elements, although particularly effective, generate costs which are however too large for certain products, particularly if they are very high volume products.

It is known, for example from patent FR 2931973, to use identification printings associated with marks, referred to as anti-copy marks, with determination of the degradation of the printing during reproduction in such a way as to prove that a printing does not correspond with an original. In these solutions, the authenticity control presents problems because it cannot be accessed by widely distributed means, such as computer telephones (smartphones). It requires an expert control mode that is not accessible to unequipped and unqualified operators, which significantly extends the decision time since analyses need to be carried out in a laboratory. In the cited prior art, the control consists in comparing a difference in variation between a printed image and a source file having been used for the printing, however this difference can be very large in so far as it adds together, without distinction, the alterations relating to the precision of printing and to the printing conditions used. Thus, the taking of a decision to declare a print authentic or not can become very random.

There is therefore a real interest in producing secure markings that can be printed on ordinary media using ordinary means, such as industrially-available printers, and for which the fraudulent reproduction would also be easily detectable using ordinary and widespread means such as smartphones.

### SUMMARY

The disclosure provides a solution to these difficulties by proposing a marking for an authentication method by means of an anti-copy pattern, said marking having features preventing the faithful reproduction of the anti-copy pattern and, preferably, encoding data for its authentication.

More particularly, the disclosure proposes a marking for an authentication method comprising two parts, a first part comprising a visible anti-copy device pattern produced from a pseudorandom noise generated from a generation secret key. The marking of the disclosure is characterised in that a second part of the marking has a pattern comprising a two-dimensional matrix code comprising:
a digital data layer comprising elementary modules arranged in a matrix, and
an authentication layer comprising graphic elements arranged in relation to and in said elementary modules in order to encode data for controlling said marking.

A marking including said two parts is more difficult to faithfully reproduce. Specifically, the adjustments for the reproduction of each part lead to the deformation of the other part, for example the improvement of the matrix code to the detriment of the anti-copy pattern, or again the visual improvement of the elementary modules of the matrix code to the detriment of the quality of the graphic elements of this same matrix code. The data encoded in said matrix code are therefore easily lost when the marking is reproduced by any copying means.

In an aspect of the present disclosure, a sub-pattern is present in a part of the elementary modules, said sub-pattern having a contrast line opposite a line of graphic elements. The sub-pattern is arranged in the elementary modules of the matrix code having a contrasting background colour opposed to a background colour of the elementary modules comprising the graphic elements.

In an aspect of the present disclosure, the elementary modules of the matrix code have dimensions substantially greater than the dimensions of the details of the anti-copy pattern generated by means of a pseudorandom noise, and the sub-patterns of the elementary modules comprise characteristic dimensions of the same order of magnitude as those of the anti-copy pattern.

The disclosure also concerns a method for printing and authenticating, wherein a printed marking produced from the observation of one or more original markings will be detected as an illicit copy of an original marking.

The method for printing and authenticating a marking, said marking comprising a visible printed anti-copy pattern produced by a pseudorandom noise that is generated from a generation secret key, comprises a step of processing at least one image of the printed anti-copy pattern.

More particularly, according to the method of the disclosure:
in a step of printing an original marking, the anti-copy pattern is printed on a marking medium using predetermined printing conditions;
a control phase of a marking, comprises the steps of:
regenerating the pseudorandom noise from the generation secret key;
creating, by calculation, a digital file of an image of a simulated anti-copy pattern, corresponding to a projected printing quality of the regenerated pseudorandom noise, by means of a mathematical model representative of the predetermined printing conditions implemented in order to print the anti-copy pattern during the printing step of an original marking;
capturing at least one image of the printed anti-copy pattern (ACCp);
comparing the at least one captured image of the printed anti-copy pattern with the image of the simulated anti-copy pattern in order to determine, by calculation, a mathematical distance between the image of the printed anti-copy pattern and the image of the simulated anti-copy pattern.

The disclosure is characterised in that:
the marking is printed by means of a selected printer model (SPM) and by using a native printing resolution of said selected printer model, in other words the best effective resolution provided by said selected printer model without requiring image processing to be applied by an operator and/or an operating software of the printer, and
in that the marking is printed from a source file generated by using a definition corresponding to at least the native resolution of the selected printer model.

Hence, preferably and according to an advantageous feature of the disclosure, the source file of the anti-copy pattern sent to the printer is generated using a definition exactly corresponding to the native resolution of the selected printer, in other words, the minimum definition allowing printing of a marking of predefined dimensions at the native resolution of the selected printer model. Of course, the definition can also be greater than the native resolution of the printer. The printing of the anti-copy pattern is also made with the same native resolution of the printer. In this way, an optimum quality printing is obtained with respect to the selected printer type and the printing is free from aberrations related to image processing in order to digitally improve the printing resolution. Hence, according to the disclosure, the following steps are implemented in order to print the markings:
the native resolution of the printer is determined from the manufacturers data for the printer,
a source file is generated comprising anti-copy markings with a definition at least corresponding to said native resolution of the printer,
the source file is printed by setting the printer to the native resolution.

Thus, a real image of a printed anti-copy pattern of a marking to be controlled is compared with a calculated image of a simulated anti-copy pattern, knowing the actual conditions of generating and printing of a printed anti-copy pattern of an original marking, the printed anti-copy pattern of an original marking being, by construction, necessarily very close, in particular in terms of its mathematical distance, to the simulated anti-copy pattern.

In an aspect of the present disclosure, the mathematical distance between the image of the printed anti-copy pattern and the image of the simulated anti-copy pattern is determined by the deviations between the image of said printed anti-copy pattern and the image of said simulated anti-copy pattern, and this mathematical distance is compared to a threshold distance. The marking is considered as original and authentic if the mathematical distance determined is less than or equal to the threshold distance, and is assumed fraudulent, for example through an attempt at reproduction of an original marking, if the mathematical distance is greater than the threshold distance.

Hence, the determined mathematical distance makes it possible to quantify a similarity between a printed anti-copy pattern and an anti-copy pattern simulated by calculation, and to distinguish by this distance whether an anti-copy pattern has been printed or not by using predetermined printing conditions necessarily used for an original and authentic marking as well as the original anti-copy pattern.

According to various aspects of the present disclosure, the method comprises the following features, alone or in functionally achievable combinations, and in any order logically compatible with the desired result:
the comparison of the image of the printed anti-copy pattern with the image of the simulated anti-copy pattern, in order to determine the mathematical distance, uses a cross-correlation calculation algorithm and/or a calculation of sums of the absolute differences between the images;
determining the threshold distance, for example experimentally and/or by simulation, in a preliminary step in order that a probability that an original printed anti-copy pattern is assumed to be a fraudulent reproduction is less than a chosen value of a false rejection rate for the predetermined printing conditions;
the threshold distance is determined, for example experimentally and/or by simulation, in a preliminary step in order that a probability that a fraudulent printed anti-copy pattern is considered to be original is less than a chosen value of a false acceptance rate for the predetermined printing conditions. In a complementary manner, the threshold distance can also take account of the image capture device used for the control.
the predetermined printing conditions comprise features of a selected printer model and a selected printing resolution;
the selected printing resolution is the native resolution of the selected printer model, in other words the best effective resolution provided by said selected printer model without image processing, for example for the purposes of smoothing, extrapolation, interpolation, colour depth modification, resizing or resampling needing to be applied by an operator and/or a software operating the printer. Therefore, the definition of the file sent to the printer and the printer settings are set to the same resolution, which corresponds to the native resolution of the printer.
the definition of the pseudorandom noise used for printing the anti-copy pattern corresponds to the selected printing resolution and advantageously the selected printing resolution is the native resolution of the printer;
the predetermined printing conditions comprise features of the marking medium and physicochemical interactions between said marking medium and the inks used for the step of printing an original marking;
the predetermined printing conditions of the step of printing an original marking comprise predefined physical dimensions with which the printed anti-copy pattern must be printed on the marking medium;
checking whether dimensional deviations between the measured physical dimensions of the printed anti-copy pattern and the predefined physical dimensions are or are not included within the predefined dimensional tolerances, and declaring that the marking is presumed original if the dimensional deviations are included in the predefined dimensional tolerances and that the marking is fraudulent if this is not the case. For clarification, “presumed original” means that the dimensional control step is positive, however the authenticity of the marking remains conditional on the determination of the mathematical distance between the image of the printed anti-copy pattern and the image of the simulated anti-copy pattern.
the measured physical dimensions of the printed anti-copy pattern are determined by digital processing of the at least one captured image of the printed anti-copy pattern obtained by an image capture system, said digital processing taking account of a focal length of the lens of the image capture system, and of a focusing distance of the lens;
the focusing distance of the lens of the image capture system is fixed at a value imposed during the acquisition of the image of the printed anti-copy pattern;
the marking comprises a two-dimensional matrix code comprising a layer of digital data in the form of elementary modules arranged in a matrix, and an authentication layer in the form of graphic elements arranged in relation to said elementary modules for coding data;
there is a sub-pattern in the elementary modules having a contrasting background colour opposed to a background colour of the elementary modules comprising the graphic elements, said sub-pattern having a contrast line opposite a line of the pattern of graphic elements. For example, the elementary modules are black and white squares, and the white squares comprise the graphic elements in the form of a black-coloured square corner, and the black squares comprise the sub-pattern in the form of a white-coloured square contour. Hence, said sub-pattern will be deformed during a balance of contrast and/or brightness carried out to improve the faithfulness of reproduction of the pattern of graphic elements, and vice versa.
the patterns of the matrix code have substantially larger dimensions than the dimensions of the details of the anti-copy pattern generated by means of a pseudorandom noise corresponding to the printing resolution, such that the optimisation of contrast and/or of brightness for the reproduction of the matrix code causes a loss of faithfulness in the reproduction of the anti-copy pattern;
all or part of the generation secret key is extracted from data contained in the printed marking;
the data contained in the printed marking, from which all or part of the generation secret key is extracted, are encrypted, for example in a two-dimensional matrix code of the printed marking;
all or part of the generation secret key is known to a reader used for implementing said authentication method;
a step of downloading, by the reader, all or part of the generation secret key;
the mathematical model representative of the predetermined printing conditions, implemented in the reading step, calculates a printing quality of a printer of the selected printer model at the selected printing resolution;
the mathematical model representative of the printing conditions implemented in the reading step, calculates a printing quality of the printer of the selected printer model using inks on the marking medium.
the control phase of the marking is implemented by a smartphone.

### BRIEF DESCRIPTION OF THE DRAWINGS

The disclosure is described in detail with use of a non-limiting example of the structure of the mark and the methods for the production and control thereof, with reference to the drawings which show, by way of a non-limiting example:

FIG. 1a: a graphical representation, which is almost perfect on the large-scale, of the content of a digital file generating the pattern to be printed on a marking;

FIG. 1b: an enlarged detail of the matrix code of FIG. 1a (the part surrounded by a dot-dash line in FIG. 1a);

FIG. 1c: an enlarged detail of the anti-copy pattern of FIG. 1a (the part surrounded by a dot-dash line in FIG. 1a);

FIG. 2a: the reproduction of a photograph of the marking obtained during the printing from the digital file, graphically materialised in FIG. 1a, and enlarged in order to be shown with the same dimensions;

FIG. 2b: an enlarged detail of the matrix code of FIG. 2a (the part surrounded by a dot-dash line in FIG. 2a). The detail in FIG. 2b corresponds to that of FIG. 1b extracted from FIG. 1a;

FIG. 2c: an enlarged detail of the anti-copy pattern of FIG. 2a (the part surrounded by a dot-dash line in FIG. 2a). The detail in FIG. 2c corresponds to that of FIG. 1c extracted from FIG. 1a;

FIG. 3: a simplified diagram of a line for producing labels according to the method of the disclosure;

FIG. 4: a simplified diagram of a system for reading and controlling the authenticity of labels printed according to the method of the disclosure;

FIG. 5: a simplified block diagram of the method for printing a marking;

FIG. 6: a simplified block diagram of the method for controlling a marking.

In the figures, the patterns shown, corresponding to printed markings, are only an example of a pattern provided in support of the description, these patterns being a priori variable in their details in order to produce different markings of a marking group and able to appear very different between different label groups. The term “marking” should be considered herein for the graphical representation of its content, whatever the printing medium.

### DETAILED DESCRIPTION

The present disclosure should be considered in that it uses printing techniques which allow printed patterns to be formed on a medium, optical reading techniques, which allow images of the printed patterns to be captured for processing, cryptographic techniques enabling secret codes to be generated and decoded, and control techniques enabling rights-holders and entitled persons to check and certify an original marking.

In general, the term “printer” will be used to designate printing means, whatever the printing technologies and techniques which may be used.

For example, the printer may be a digital printing press, or an inkjet, laser, thermal, offset or flexography printer etc., this list not being exhaustive.

The term “reader” will be used generically to designate a system for reading markings and for digital processing, comprising a device for optical reading of the printed patterns of a marking and for delivering simple or streaming images in the form of digital files representing the printed patterns read, whatever the optical reading technologies and techniques that may be used, and the system for processing said digital files which is associated with said optical reading device.

For example, a reader may use a laser scanning device with photosensors that are in-line (strip of cells) or arranged in a matrix (photographic sensor), which device may be incorporated in a specific reader or in a generic apparatus, for example a scanner, a photocopier or a camera. Advantageously, it will use a computer phone, commonly called a smartphone, equipped with an image sensor and which will be configured to be used as optical reading and digital processing means. The latter will be able to be operated autonomously and/or connected and/or by embedding a proprietary USB encryption flash drive specific to each use.

The disclosure also takes into consideration that any printer and any reader will have imperfections. Imperfections or defects are intrinsic to any physical system.

It is known in the case of printers, that the graphic shapes printed are not strictly identical to the desired graphic shapes which are sent to the printer in the form of a digital printing file. In particular, a graphic shape once printed differs from the desired shape through distortions, imprecisions in the contours and other artefacts related, in particular, on the one hand to the printing resolution of the printer and on the other hand to the printing technology that it uses.

The performance of printers is variable from one printer model to another but, for a given printer, there are always dimensions of a printed pattern for which printing defects are observable on the scale of the pattern. It should also be noted that each type of printer has its own specific behaviours, which results in printing results of certain particular patterns, as a function of the type of printer and the printing conditions, which are predictable and/or recognisable. The present disclosure utilises this possibility of predicting a printing behaviour in order to simulate the printing result of an anti-copy pattern as a function of the predetermined printing conditions.

Equivalent observations apply in the case of readers.

In particular, the optical systems are associated with resolutions and distortions that differ from one optical system to another depending on the quality of the optical system, but which are always observable with appropriate means.

The present disclosure takes advantage, on the one hand of imperfections or specific properties of printers which it uses in a process for producing printed markings and in attempts at fraudulent reproduction of the markings, and on the other hand of secret encryption keys for protecting the content and/or the printed patterns.

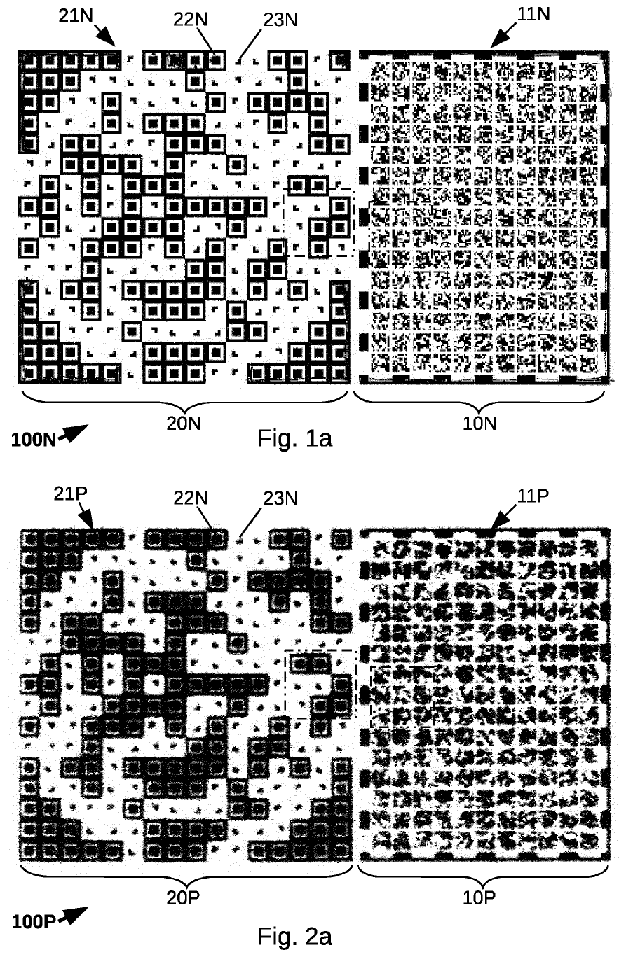

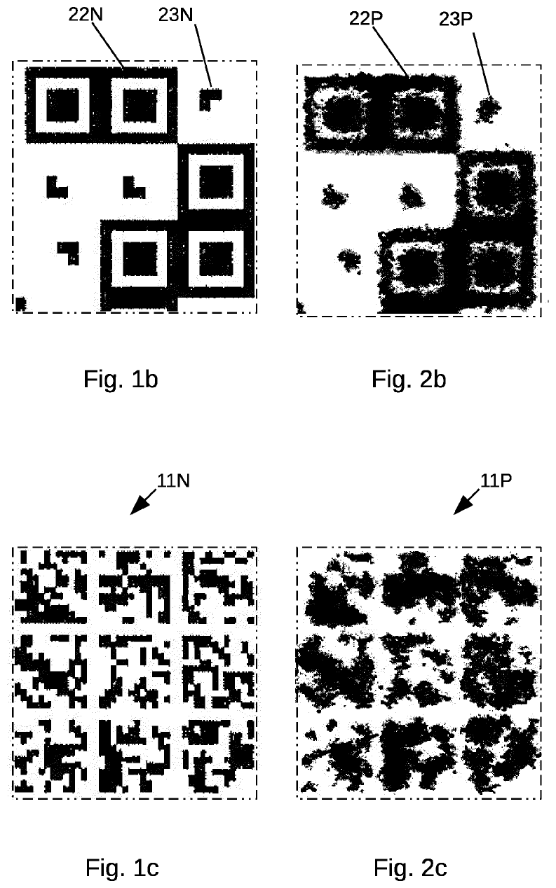

FIG. 1a shows an example of a marking pattern that can be printed on a medium, for example on a label.

The illustration of FIG. 1a can be considered as perfect insofar as the dimensions of the printed pattern make it possible to distinguish, without ambiguity, each elementary point of the image of the pattern which corresponds to a digital file in which, for example, a white point corresponds to a value of 0 and a black point corresponds to a value of 1 in said digital file.

This graphic quality of the pattern stems from the fact that the pattern of the figure has been printed in greatly enlarged form, thus with a print resolution that is significantly greater than the resolution of the pattern, the imperfections of the printing then becoming imperceptible on the scale of observation of the overall pattern, at most insufficient for preventing the reconstruction of the original digital file as shown by the enlarged details shown in FIGS. 1b and 1c (enlargement of the area in the dashed-line box of FIG. 1a).

An optical reader of the pattern of FIG. 1a produced with a known reader would therefore allow the original digital file to be reproduced without difficulty and would subsequently allow printing of identical labels with the same quality, which could not be distinguished from the original label.

FIG. 2a in turn shows an enlarged photograph of the result of the printing of the pattern of FIG. 1a at the envisaged dimensions of the marking. In this case, many imperfections, resulting from the transfer function of the printer and also from that of the reader which has been used for this photograph, become apparent on the scale of the overall pattern, as shown more precisely by the details, shown enlarged still further in FIGS. 2b and 2c, of the same areas as those of FIG. 1a enlarged in FIGS. 1b and 1c.

These enlarged photographs of FIG. 2a, as obtained with a high-performance reader, illustrate that it is not possible to exactly reconstruct the original digital file of the pattern as is possible from the representation of FIG. 1a, at least for the non-intelligible patterns such as those represented in FIGS. 1c and 2c.

The aspects disclosed above are implemented in the disclosure in order to distinguish an original printed marking from a printed marking that is illicitly reproduced from an original printed marking.

### General Structure of a Marking

FIG. 1a, examined above, represents an example of a structure of a marking 100N according to the disclosure, this representation being here an exact graphical representation of the digital file which generated it.

According to this structure example, the marking comprises two distinct parts in FIG. 1a. In practice, the marking may comprise other informative or decorative parts, but these other parts are not considered here. Only the parts of the marking illustrated in FIGS. 1a and 2a will be examined in the remainder of the description and jointly designated by the term “marking” or by the term “label” in an example of a printing support.

A first part 10N, on the right of the illustration of FIG. 1a, forms a native anti-copy pattern ACCn, the structure of which is described further on in the present description.

A second part 20N, on the left of the illustration of FIG. 1a, comprises a two-dimensional native matrix code MCn, belonging to the family of codes known by the names “Datamatrix” or “OR-Code”.

As has been disclosed, the native anti-copy pattern and the native matrix code are exact graphic representations of the digital file of which here they are only a materialisation.

### The Anti-Copy Pattern ACC

The native anti-copy pattern ACCn, is not intelligible in the sense that it does not correspond to data that can be used for any purpose other than the representation of said anti-copy pattern.

It does not contain stored data but corresponds to a pseudorandom noise signal PRN generated from a generation secret key GSK.

For this reason, apart from an exact optical reading of the exact graphic representation of the native anti-copy pattern ACCn, in practice it is impossible to recover the calculation of the original digital file corresponding to it without possessing the generation secret key GSK, and the algorithm used to generate said original digital file.

This property is exploited in order to secure the marking as described below.

### The Matrix Code MC

The native matrix code MCn, represented graphically in FIG. 1a, comprises, in the illustrated aspect of the present disclosure, a data layer, composed of elementary modules 22N representing two distinct states of a binary value, for example black or white squares, arranged in a matrix in order to correspond with data stored in digital form.

The stored data can be of any known type: numeric, alphabetic, binary.

In practice, the matrix code MCn comprises a number of modules adapted to the volume of data which needs to be encoded, generally at least 12 elementary modules along a height and 12 elementary modules along a width of said matrix code, and, in the example illustrated in FIG. 1a, comprises 16 elementary modules in height and 16 elementary modules in width.

In a known manner, such as in the Datamatrix or OR-Codes, the matrix code is produced in order to enable the implementation of error correction functions, of the Reed Salomon type for example, which make it possible to ensure the integrity of the data obtained by reading said matrix code.

This native matrix code is preferably “proprietary”, in other words it has been constructed using a secret encryption algorithm and a particular algorithm must therefore be used in order to interpret the information contained in the MCn. A particularly judicious means for interpreting and decoding the MCn is to use a specific application available on the smartphones of authorised controllers.

In the illustrated example, the native matrix code MCn also comprises an authentication layer.

The idea of layers of the matrix code should be considered in the present description in the logical sense, in other words the two layers do not have the same functions. On the material level, they are, a priori, produced in the same way by printing patterns on a same medium.

The authentication level comprises graphic elements 23N arranged relative to the elementary modules 22N of said matrix code in order to encode information that is only accessible via a secret key that is known by the reading tool. Moreover, the different patterns formed by the elementary modules 23N and the graphic elements 22N have been selected in order to detect variations in contrast that a counterfeiter would have to make in order to produce the authentication element with maximum faithfulness.

Here, graphic element means a representation of a symbol or alphanumeric character, by a line or lines on a figure.

In order to improve the anti-copy effect of the matrix code (MCn), the disclosure proposes also incorporating a sub-pattern in the elementary modules 22N which do not comprise a graphic element 23N. This sub-pattern can also correspond to a representation of a symbol or alphanumeric character, by a line or lines on a figure. In FIG. 1, this sub-pattern corresponds to a white square contour in the black elementary modules 22N, and the graphic elements 23N correspond to a black right angle symbol in the white elementary modules 22N.

When an authentication layer of the matrix code is implemented, the graphic elements 23N are advantageously calculated using a hash function of the data of the matrix code from the data layer of said matrix code.

The hash function advantageously uses a key, a part of which is incorporated, during the matrix code generation, in the data contained in said matrix code.

In the context of the disclosure, the method for authenticating a marking can be implemented without the presence of said matrix code MCn, by means of the printed anti-copy pattern only. Nevertheless, the presence of the matrix code MCn in the marking improves the security of the authentication method in that it provides the faithful reproduction of the printed anti-copy pattern and can encode data for the control of said marking.

Below, examples will be given of aspects of the present disclosure of the anti-copy pattern associated or not associated with a matrix code.

### Producing a Marking

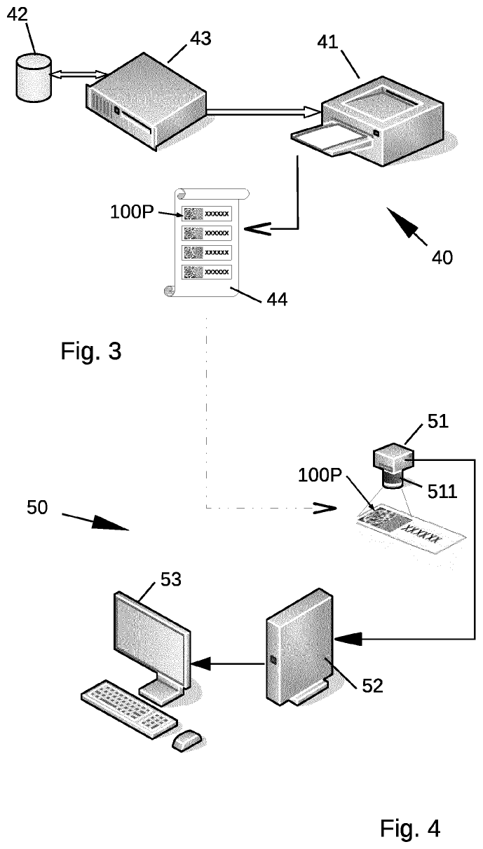

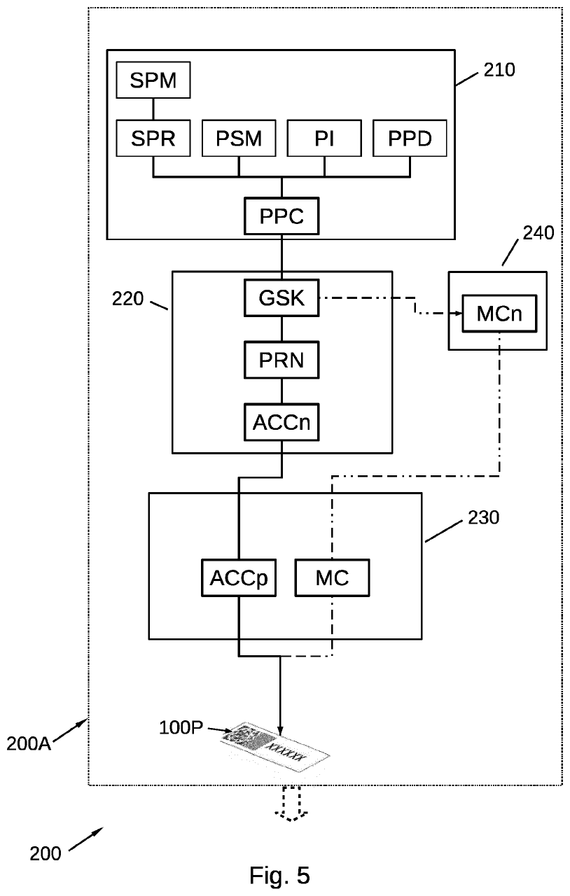

FIG. 3 schematically shows a printing system 40 for labels used as marking media PSM, and FIG. 5 shows a simplified block diagram of the phase 200A of producing the marking in the printing and authentication method 200.

In a step 210 prior to the production of a printed label 100P, more particularly a plurality of labels belonging to the same category or family of labels, predetermined printing conditions PPC are defined which are implemented in order to produce the marking or markings of the family of labels.

Said predetermined printing conditions advantageously comprise:
a selected printer model SPM;
a selected printing resolution SPR;
a marking medium PSM and inks P1 to be used;
predefined physical dimensions PPD of the anti-copy pattern to be printed.

These various criteria may or may not be taken into account in the predetermined printing conditions PPC depending on their effects on the performance of the method of the disclosure which will be examined later in the description.

For example, the inks P1 may be imposed by the printer model.

Conversely, the selection of particular inks may prove to be more important than the selection of a particular printer model.

For example, the selection of a marking medium PSM may lead to an effect that is not very sensitive for the performance of the method for a range of inks depending on the physicochemical interactions PCI between the marking medium and the inks.

A person skilled in the art will therefore determine the printing conditions, for example on the basis of test results, in order to define the features which are imposed in the predetermined printing conditions PPC, not only so that the printing results of the anti-copy pattern are of stable quality, but which is however sufficiently discriminating so that a mathematical model can be constructed that is usable in order to establish a projected printing quality.

In an aspect of the present disclosure, the predetermined printing conditions PPC include the definition of a selected printer model SPM, which will be used with a selected printing resolution SPR, inks P1 and the marking medium PSM to be used with the printer 41 in order to produce the marking, and predefined physical dimensions PPD of the anti-copy pattern.

In order to implement the method, it is preferred that the pseudorandom noise PRN has a texture, the details of which will be printed with a printer having a selected printing resolution SPR of at least 500 points per inch, i.e. approximately 20 points per millilitre, which gives details of order 0.05 millimetres.

The size of the details also depends, where appropriate, on the type of printer, the type of medium (depending on the absorption of the inks, the quality of the support etc.) and the type of inks.

According to a feature of the disclosure, the definition of the anti-copy pattern is fixed and said anti-copy pattern is printed with the same definition in order to correspond to the selected printing resolution SPR so that the deviation between neighbouring image points of the printed anti-copy pattern ACCp coincides with a deviation between the points printed by the printer, said deviation therefore being equal to the inverse of the selected printing resolution SPR.

The selected printing resolution SPR is advantageously equal to the native resolution of printers of the selected printer model SPM. According to this feature of the disclosure, the definition of the printing file sent to the printer is therefore identical to the native resolution of the selected printer and the printing is performed at this same native resolution.

The native resolution of the printer corresponds here to the maximum printing definition of the printer without image processing (such as: smoothing, extrapolation, colour depth modification, resizing or resampling etc.) needing to be applied by an operator and/or printer operating software.

Operating at the native definition of the printer makes it possible, under the predetermined printing conditions, to protect more exactly the result of a printing, while retaining the maximum printer capability to produce difficultly reproducible patterns.

When the prerequisites are determined, the digital printing file 42 responding to the resolution requirements can be constructed 220 for each marking, or series of markings, to be printed.

A generation secret key GSK, known in the method, that is arbitrarily selected or, preferably, generated by any chaotic process, is used as a seed for calculating a pseudorandom sequence.

An algorithm is then used to transform said pseudorandom sequence into a pseudorandom noise PRN.

By way of non-limiting example, the pseudorandom noise is Perlin noise. Perlin noise, which is part of the family of gradient noises, makes it possible to generate a procedural texture which is used to texture the image of the native anti-copy pattern ACCn intended to be printed in the marking. This type of texture will then make it easier to discriminate between an original print and an attempted copy, by increasing significant measurement deviations between the two prints.

The algorithm for generating pseudorandom noise PRN can be configured in various ways, in particular by taking into account the printer model and/or the printer adjustments and/or the marking medium and/or the type of inks and/or environmental parameters. Each configuration results in introducing a different printing noise, which translates into a graphic representation of the pseudorandom noise with different textures. The choice of parameters is performed, for example, in an experimental manner, by performing test printings, and the parameters leading to the most discriminating variations in the pseudorandom noise will be selected in the predetermined printing conditions PPC.

The native anti-copy pattern ACCn once determined is associated with other data constituting the marking, then the marking is printed 230 on the marking medium PSM in accordance with the predetermined printing conditions PPC, at least for the part of the marking containing the printed anti-copy pattern ACCp. By way of example, in step 230, a serial number can be associated with each marking for the purposes of traceability. Advantageously, this serial number can be represented in the form of a datamatrix or QR code.

During the printing 230, the printer 41 and the interactions between the inks used by the printer and the marking medium have the effect of transforming the native anti-copy pattern ACCn, a graphic representation of which is illustrated in FIG. 1a, in order to produce the printed anti-copy pattern ACCp, for which FIG. 2a shows the actual image, different from that of the native anti-copy pattern which gave rise to it.

The printed anti-copy pattern ACCp thus obtained corresponds to an original or first-generation marking which, provided it meets the identity criteria, is considered to be authentic.

The marking is printed on the medium 44, in order to form a printed label in the example of FIG. 3.

The digital printing file 42 is transmitted to the printer 41 and the marking is printed on the medium while observing the conditions determined in the preliminary step 210.

The defects created by the printer 41 during printing have the effect of altering the printed patterns with respect to their ideal representations of the digital printing file 42, so that said digital printing file, materialised in FIG. 1a, will only be approximately represented, as illustrated in FIG. 2a of the strongly enlarged marking.

It should also be noted that a plurality of markings printed with the same printer, meeting the same predetermined printing conditions PPC and using the same digital printing file 42, although very similar will not be strictly identical, and differences will always be observed between the printed anti-copy patterns, at least on the scale of the selected printing resolution SPR of the printer.

Such markings are termed original or first-generation.

Such markings are also authentic due to the fact that they have been produced according to the method of the disclosure and they will be distinguished, as will be explained below, according to the method, from another marking produced, in particular, in an attempt to reproduce a first-generation marking from said printed first-generation marking.

When the marking comprises a matrix code MC, the data which must be encoded in said matrix code are incorporated 240 in the digital file of the native matrix code MCn.

In an aspect of the present disclosure, the generation secret key GSK is incorporated in the first layer of the native matrix code of the marking, advantageously encrypted.

In another aspect of the present disclosure, only a part of the generation secret key GSK is incorporated in the first layer of the native matrix code MCn of the label, advantageously encrypted.

It is also possible to use a matrix code without this comprising all or part of the generation secret key.

The digital printing file is the result of the concatenation in a given code file of the data layer of the matrix code MC, if applicable of the authentication layer of said matrix code, and of the native anti-copy code pattern ACCn.

The data layer of the native matrix code MCn is defined in order to store conventional data and, in an aspect of the present disclosure, data used for the purposes of decrypting, for example decryption keys, encryption specifications, decryption algorithms.

The authentication layer of the native matrix code MCn, when the label uses such a layer, is calculated by implementing a hash function of the data layer data, the key of which is known from the software application of the reader, before subsequently carrying out the authentication control.

In another aspect of the present disclosure, said key is incorporated in the data layer of the matrix code MC of the label.

In another aspect of the present disclosure, said key is partially known from said software application and the complement to said key is incorporated in the data layer of the native matrix code MCn of the label.

Said key is then reconstructed during the reading and control operations by recombining data incorporated in the data layer of the matrix code MC of the label with those known from the software application.

In the case of data used for decryption purposes, the data layer of the matrix code MC stores dynamic information necessary for the decryption of the authentication layer of said matrix code.

The various calculations required for the construction of the digital printing file 42, image of the label, are carried out by one or more calculation units 43 on which the marking generation applications are implemented.

The predetermined printing conditions PPC determined for the anti-copy pattern advantageously also apply to the matrix code MC.

For example, the elementary module 22N has a sub-pattern with characteristic dimensions of the same order of magnitude as those of the anti-copy pattern, without the defects, which may be introduced when printing, harming the intelligibility of the code contained in the data layer.

The example illustrated in FIG. 1a and the detail of FIG. 1b, shows a combination of sub-patterns of modular elements 22N and a pattern of the graphic element 23N cleverly chosen to force a counterfeiter wishing to produce a photocopy, to use a precise printer setting in order to reproduce both types of patterns and keep them interpretable. Specifically, a strong contrast will have the effect of making the white contours of the pattern 22N disappear and, conversely, a weak contrast will have the effect of making the readability of the pattern of the graphic element 23N disappear. The patterns preferably have a form and a position so as to render reproduction complex. Through this provision, the counterfeiter is obliged to have a printer with a printing quality and definition of the same order of magnitude or greater as the printer that was used to print the original code.

Therefore, according to a particularly advantageous feature of the disclosure, the code MC acts in combination with the code ACC to prevent attempts at photocopying the marking 100P. Specifically, the pattern MC imposes a very precise setting of the photocopier or the printer and the inventor has selected the pseudorandom noise PRN so that said precise setting prevents a faithful reproduction of the part ACC. According to another feature, the pattern MC constitutes an anti-photocopy marking, whereas the pattern ACC constitutes a marking that is impossible to reconstitute.

### Controlling a Marking

The markings are affixed on the destination products in a conventional manner, for example by transferring a label after printing the marking on an adhesive medium, for example by direct printing on a product, on a packaging of the product, on a document or on a product documentation.

In a known manner, the labels, when they are used, use an adhesive and/or precuts, which guarantee their destruction in the event of an attempt to unglue them for a fraudulent reuse.

When it is necessary to control the origin of the product on the basis of its marking, it is important to verify that the marking itself is authentic.

The authenticity of the marking is verified during a control phase 200B of the method 200.

In the exemplary aspect of the present disclosure described, the authenticity of the marking is controlled by a double verification relating on the one hand to the physical dimensions of the printed anti-copy pattern ACCp of the marking and, on the other hand, to a mathematical distance Dif between said printed anti-copy pattern ACCp and a simulated anti-copy code ACCsim, said mathematical distance translating a probability that the verified marking is or is not first-generation.

It will be noted here that the verification of the physical dimensions of the printed anti-copy code is not necessarily carried out in the method of the disclosure.

It however concerns a means for detecting whether the marking is non-compliant with this criterion, with an authentic marking with particular acuity when it is carried out by a reader and which can be implemented in a fully automated control process.

However, even a rough verification of the physical dimensions of the anti-copy code, for example by a visual examination of an operator, makes it possible to detect a fraudulent reproduction of the printed anti-copy pattern which, sufficiently enlarged, would permit the verification by the mathematical distance to be defeated. The order of the two verifications is not imposed, but advantageously the verification of the physical dimensions, which is simpler to implement, will be carried out first in order to avoid carrying out mathematical distance calculations on anti-copy codes for which the fraudulent nature is certain.

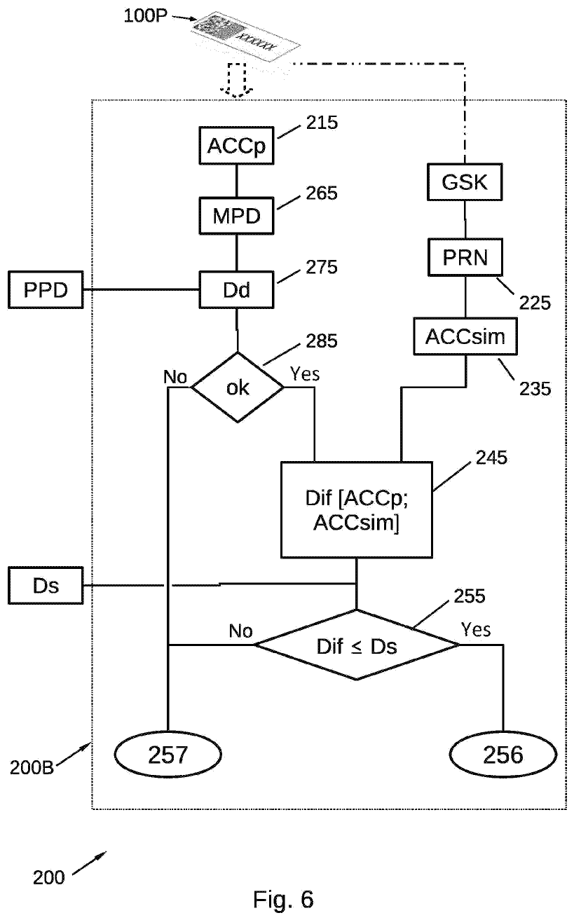

FIG. 4 schematically illustrates a reader 50 of a printed marking 100P, and FIG. 6 represents a simplified block diagram of the control phase 200B.

Functionally, the reader 50 comprises an optical device 51 for capturing images of the marking, images which are transmitted to a processing unit 52 of said reader in order to carry out calculations on the images, for example in the form of a video stream.

The reader can be a specialised device designed for this purpose, such as for example a box comprising a processor and/or connection means to one of the more or less remote digital processing resources and comprising an image sensor.

Advantageously, in a portable version, the reader is a computer telephone, or smartphone, having a digital camera, capable of digital processing and comprising an application dedicated to reading markings.

The control of the mathematical distance Dif associated with a printed anti-copy pattern ACCp is carried out by implementing the following steps.

In the following, it will be considered that said printed anti-copy pattern is readable and has the structure of an anti-copy pattern that can be interpreted as such by the reader 50 used, taking account of the configuration of said reader.

In a first control step 215, the reader 50 is used to capture one of the images of the marking to be controlled and, more particularly, of the printed anti-copy pattern ACCp.

In a second control step 225, the reader 50 regenerates the pseudorandom noise PRN from the generation secret key GSK and algorithms used to create a digital file identical to the file assumed to have been used to print the printed anti-copy pattern ACCp when the image was captured in the preceding step.

In a third control step 235, an image is calculated of a simulated anti-copy pattern ACCsim. Said image of the simulated anti-copy pattern ACCsim corresponds to a projected printing quality of the regenerated pseudorandom noise PRN, and is calculated by means of a mathematical model simulating the predetermined printing conditions PPC, assumed to correspond to the conditions under which the controlled marking has been printed.

In a fourth control step 245, the captured image of the printed anti-copy pattern ACCp is numerically compared with the image of the simulated anti-copy pattern ACCsim in order to determine, by calculation, a mathematical distance Dif between the two images.

The mathematical distance Dif translates the differences which are observed between the two images. The mathematical distance must reflect the physical differences in printing, such as for example differences in texture and/or change in ink density and/or colour. The larger the distance, the greater the differences between the two images, and vice versa.

Algorithms are known for calculating the differences between two images. They are used, for example, in deformation measurements, in non-destructive inspection and in the field of video stream compression. It is possible to use, among others, a cross-correlation algorithm or a calculation of the sums of the absolute differences between the images.

Such a correlation between the two images is obtained, for example, from the calculation of the variance between the two images, for which an example of a mathematical distance calculation between two functions is given by the following variance calculation formula:

$$V ( X ) = \frac{{\sum }_{i = 1}^{N} {( X i - moy ( X ) )}^{2}}{N} \qquad$$

where:

V(X): represents the variance of the difference of the pixels of two images

Xi: represents the difference in the value of a pixel between the two images

moy(X): represents the mean of the differences of the values of the pixels

N: is the number of pixels within the images (the calculated images have the same number of pixels).

In a fifth control step 255, the mathematical distance Dif calculated in the preceding step is compared with a threshold distance Ds. If the mathematical distance Dif is less than or equal to the threshold distance Ds, the marking is assumed authentic 256, provided that other controls performed do not contradict this conclusion.

The threshold distance Ds is selected in a preliminary step of the method in order that, for the first generation markings for which the anti-copy pattern originates from the generation secret key GSK, the mathematical distance Dif is less than or equal to the threshold distance Ds, at least having a false rejection rate Tfr less than an, in principle low, selected value.

Indeed, as has already been observed, it is not possible to fully predict the result of a printing of a given marking, and between two supposedly identical printings carried out on the same printer, all the more so with different printers, observing the same printing conditions PPC and on marking mediums PSM of the same type, there will always be a non-zero mathematical distance.

However, through the choices made, this last mathematical distance will be contained and will make it possible to determine, experimentally and/or by simulation, a value of the threshold distance Ds for which, with a desired probability, all of the authentic printed anti-copy patterns ACCp produced using the same predetermined printing conditions are separated from the simulated anti-copy pattern ACCsim by at most the threshold distance Ds.

In contrast, all the markings for which the mathematical distance Dif between the printed anti-copy pattern ACCp and the simulated anti-copy pattern ACCsim are greater than the threshold distance Ds are assumed to be non-authentic 257.

This condition will have an increased probability of being produced if the printed anti-copy pattern has been produced by attempting to reproduce the anti-copy pattern from the first-generation printed anti-copy pattern, and more so for a copy from the nth generation (with n≥2).

Indeed, such a reproduction assumes that the anti-copy pattern is digitised, for example with a scanner or a camera, then printed again.

However, obtaining a digital image of the anti-copy pattern will necessarily introduce deformations with respect to the digitised pattern due to the inevitable imperfections of the digitisation means used and the subsequent printing will also add deformations and artefacts, more so if the copier does not know the data relating to the printing conditions, which will be superimposed on the first-generation anti-copy pattern which will have the effect of increasing the mathematical distance Dif calculated during an authentication control. The present disclosure thus makes use of the fact that a counterfeiter will not have access to the native anti-copy pattern ACCn and will not know the predetermined printing conditions PCC. Consequently, it will be almost impossible for him to reconstruct and print a copy of the marking with a mathematical distance Dif less than the threshold distance Ds.

As such, the threshold distance Ds can alternatively be determined as a function of a selected maximum false acceptance rate Tfa.

The choice of basing the threshold distance Ds on the false rejection rate Tfr or on the false acceptance rate Tfa is arbitrary and can be based on the importance given to the consequences of a false marking being interpreted as authentic and of an authentic marking being interpreted as false.

The verification of the physical dimensions of the printed anti-copy pattern ACCp, when it is implemented, can be carried out by any dimensional control means for measuring the dimensions of said printed anti-copy pattern.

In an aspect of the present disclosure, the measurement 265 is carried out with the reader used, which will be used in order to calculate the mathematical distance between the image of the printed anti-copy pattern ACCp and the image of the simulated anti-copy pattern ACCsim.

The measured physical dimensions MPD of the printed anti-copy pattern ACCp are compared 275 with the predefined physical dimensions PPD expected for the printed anti-copy pattern of an authentic marking in order to determine the dimensional deviations Dd between the two patterns.

In this step, the dimensions of the printed anti-copy pattern of the marking to be verified are advantageously determined by processing the captured image of said printed anti-copy pattern.

Knowledge of features of the camera device, in particular the focal length of the lens and the focusing distance, which together determine the magnification between the image of the object formed on the image sensor by the optical device and the object, i.e. here the pattern, thus make it possible to determine the measured physical dimensions MPD of the printed anti-copy pattern.

In an alternative aspect of the present disclosure, the focusing distance of the device is fixed at a value determined in advance, so that the reading of the pattern and the capture of the image can only be carried out for said fixed focusing distance, with a small margin of error given the low depth of field in a close-up imaging mode.

If the dimensional deviations Dd between the measured physical dimensions MPD and the predefined physical dimensions PPD are compatible 285, in other words within acceptable dimensional tolerances given the uncertainties linked to the conditions for determining measured dimensions, the marking will be considered authentic 256, subject to other conditions examined before or afterwards.

If the dimensions of the marking or one of its elements are outside of the tolerances, the label is declared false 257.

It will be observed that this test of the physical dimensions of the marking makes it possible to eliminate enlarged copies of an authentic marking which, due to their scale reproduction, will be graphically very similar to the authentic marking.

For example, the enlarged marking reproduced in FIG. 1c would certainly be considered as original and authentic in so far as on this scale, the novel artefacts introduced by the fraudulent reproduction would be imperceptible.

It should also be noted that the test on the physical dimensions can be carried out based on the measurement of physical dimensions of a printed pattern of the marking other than the printed anti-copy pattern, or of the complete marking, provided that the abnormal physical dimensions of the printed anti-copy pattern part are proportional to those of said printed pattern.

Any deviation of physical dimensions, of all or part of the marking, outside of tolerances considered acceptable, being by definition an indication of an illicit reproduction.

### On the Source Data

As highlighted by the description of the method for printing and authenticating a marking, for the application of the method in order to authenticate a printed anti-copy pattern, in other words to verify whether said printed anti-copy pattern is sufficiently close, in mathematical distance and where appropriate in physical dimensions, to an authentic marking, it is necessary to have:
algorithms for generating pseudorandom noise PRN, and;
the generation secret key GSK, and;
predefined physical dimensions PPD, and;
the mathematical model representative of the predetermined printing conditions PPC;
the threshold distance Ds; and
dimensional tolerances on the physical dimensions of the printed anti-copy patterns.

All of these elements must therefore be accessible to the reader 50 which carries out the reading of the marking and carries out the control.

In a general manner, and for each of the parameters, it is possible that:
the reader 50 holds, for example in a digital memory incorporated in said reader or temporarily connected to said reader, for example by a communication network, for example by a physical key, all or part of the parameter;
the marking contains, for example in the form of a printed matrix code MCp readable by the reader 50, all of part of the parameter;
a remote site, that can be interrogated remotely by the reader 50, delivers all or part of the parameter.

In any case, the reader implements protections, for example the encryption of data, in order to avoid pirating of the known parameters of the reader.

The data on the important parameters, for example the generation secret key GSK, are preferably encrypted when they are contained in the marking The printed matrix code MCp, when such a code is used, is advantageously encrypted in order only to be readable by a reader programmed to this effect.

When the parameters are held by a remote site, the marking, for example the printed matrix code MCp, contains an address of a server to which the reader, after having identified said address, connects automatically and authenticates itself in order to obtain the parameter or parameters, in whole or in part, that it must download, if applicable storing said parameters for an off-line authentication control of markings.

The designer of the reader therefore has options for applying the method.

When there is a large number of markings with printed anti-copy patterns based on the same pseudorandom noise, in other words generated from the same generation secret key GSK, said secret key will advantageously be stored by the reader at least at the time of a series of controls, for example by an initial download from the server of the remote site. This solution enables the reader to carry out the controls of the markings in an autonomous manner and therefore without risking the inconvenience of connection difficulties with the remote site during the controls.

When the markings comprise printed anti-copy patterns based on different pseudorandom noises, in other words generated from different generation secret keys GSK, advantageously said generation secret keys are contained in a marking concerned, at least for parts that are variable from one marking to another to be controlled. In this way, the reader will be able to extract the generation secret key, or a specific part of said secret key, from the marking when reading said marking, in order to regenerate the pseudorandom noise PRN corresponding to the printed anti-copy pattern of said marking.

It should be understood that the matrix code MCp is formed during the printing step so that said matrix code contains the data necessary for the control step for the data that will have been selected to be incorporated in said matrix code.

In this case, the reader 50, during the reading of the marking, starts by decoding the data of the MCp in order to extract therefrom the data which are required for it to control the printed anti-copy pattern ACCp and to continue the control.

If the reader 50 does not decode the data of the MCp or if the data obtained are not coherent with the expected data, the marking is considered to be a false marking and declared as such. If not, the reader continues the control of the marking.

The authenticity control carried out on the pattern of the ACCp is justified in the remarks disclosed in the introduction of the detailed description, according to which the printers introduce inevitable defects into the printed elements, which are visible, in particular, when the printed patterns are observed on scales close to the resolution of the printer.

A first generation authentic marking thus comprises defects linked to the limits of the printer used and which distinguish this authentic marking from the theoretical digital image from which it arose.

When a counterfeiter seeks to copy a marking, he only has a first-generation marking available for this. It is impossible to reconstruct the original digital file of the native anti-copy code ACCn, which is a contingency which results in chaos on the ACCp code and for which it only holds an imperfect image given the imperfections, defects and artefacts introduced by the printing under the predetermined printing conditions of the original markings.

In doing so, the counterfeiter will have to print a second generation marking, with the dimensions of said original marking, which leads to the introduction of the imperfections, defects and artefacts of his device for digitising the marking and his printer, which will be superimposed on those of the original marking, consequently increasing the mathematical distance between the reproduction of the printed anti-copy pattern, with a second or higher generation printed code, and the simulated anti-copy pattern which is invariable and close to the authentic printed anti-copy pattern in the control method, whether or not the controlled marking is authentic.

In order that a copy of the printed anti-copy pattern appears authentic, the counterfeiter will necessarily increase the scale of printing with respect to the original which serves as a model for him. Such a copy will be detected during the control of the physical dimensions and the marking will thus be declared non-authentic.

The disclosure thus defines the features of a printed marking and its printing conditions which ensures that its reproduction by copying will be detected in a simple manner by the reader of the marking codes, even though these are reproduced on the fraudulent marking.

A particular feature of the method is that the graphic elements of the anti-copy pattern are perfectly visible and that, nevertheless, the counterfeiter cannot manage to obtain a reproduction thereof that is sufficiently faithful that it is not detected.

Recourse to complex and costly solutions and to a high level of expertise for detecting the fraudulent copy, which is generally necessary in solutions comprising hidden patterns, is therefore avoided.

What is claimed is:

1. A marking for an authentication method comprising two parts, a first part comprising a visible anti-copy pattern produced by a pseudorandom noise generated from a generation secret key, characterised in that a second part of the marking has a pattern comprising a two-dimensional matrix code comprising:
a digital data layer comprising elementary modules arranged in a matrix, and
an authentication layer comprising graphic elements arranged in relation to and in said elementary modules in order to encode data for controlling said marking.

2. The printed marking according to claim 1, wherein:
a sub-pattern is present in a part of the elementary modules, said sub-pattern having a contrast line opposite a line of the graphic elements, and
said sub-pattern is arranged in the elementary modules of the matrix code having a contrasting background colour opposed to a background colour of the elementary modules comprising the graphic elements.

3. The printed marking according to claim 1, wherein the elementary modules of the matrix code have dimensions substantially greater than the dimensions of the details of the anti-copy pattern generated by means of a pseudorandom noise, and the sub-patterns or graphic elements of the elementary modules comprise characteristic dimensions of the same order of magnitude as those of the anti-copy pattern.

4. A method for printing and authenticating a marking according to claim 1, said marking comprising a visible printed anti-copy pattern produced from a pseudorandom noise that is generated from a generation secret key, said method comprising a step of processing at least one image of said printed anti-copy pattern, and characterised in that:
in a printing step of an original marking, the anti-copy pattern is printed on a marking medium using predetermined printing conditions;
in a control phase of the marking, the following steps are implemented:
regenerating the pseudorandom noise from the generation secret key;
creating, by calculations, a digital file of an image of a simulated anti-copy pattern, corresponding to a projected printing quality of the regenerated pseudorandom noise, by means of a mathematical model representative of the predetermined printing conditions implemented in order to print the anti-copy pattern during the printing step of an original marking;
capturing at least one image of the printed anti-copy patent;
comparing the at least one captured image of the printed anti-copy pattern with the image of the simulated anti-copy pattern in order to determine, by calculation, a mathematical distance between said image of the printed anti-copy pattern and said image of the simulated anti-copy pattern, and characterised in that:
the marking is printed by means of a selected printer model and by using a native printing resolution of said selected printer model, in other words the best effective resolution provided by said selected printer model without requiring image processing to be applied by an operator and/or an operating software of the printer, and
in that the marking is printed based on a source file generated using a definition corresponding to at least the native resolution of the selected printer model.

5. The method for printing and authenticating a marking according to claim 4, wherein the mathematical distance between the image of the printed anti-copy pattern and the image of the simulated anti-copy pattern is determined by the deviations between the image of said printed anti-copy pattern and the image of said simulated anti-copy pattern, and wherein the mathematical distance is compared to a threshold distance, the marking being considered to be original if the calculated mathematical distance is less than or equal to the threshold distance, and assumed to be fraudulent if the mathematical distance is greater than the threshold distance.

6. The method for printing and authenticating a marking according to claim 4, wherein the definition of a pseudorandom noise used to print the anti-copy pattern corresponds to the selected printing resolution.

7. The method for printing and authenticating a marking according to claim 4, wherein the predetermined printing conditions comprise features of the marking medium and physicochemical interactions between said marking medium and inks used for the step of printing an original marking.

8. The method for printing and authenticating a marking according to claim 4, wherein the predetermined printing conditions of the step of printing an original marking comprise predefined physical dimensions with which the printed anti-copy pattern must be printed on the marking medium.

9. The method for printing and authenticating a marking according to claim 8, wherein it is verified whether dimensional deviations between the measured physical dimensions of the printed anti-copy pattern and the predefined physical dimensions are or are not within the predefined dimensional tolerances, said method comprising declaring that the marking is presumed original if said dimensional deviations are within the predefined dimensional tolerances and declaring that the marking is fraudulent if this is not the case.

10. The method for printing and authenticating a marking according to claim 9, wherein the measured physical dimensions of the printed anti-copy pattern are determined by digital processing of the at least one captured image of the printed anti-copy pattern obtained by an image capture system, said digital processing taking account of a focal length of the lens of an image capture system, and of a focusing distance of a lens.

11. The method for printing and authenticating a marking according to claim 10, wherein the focusing distance of the lens of the image capture system is fixed at a value imposed during the acquisition of the image of the printed anti-copy pattern.

12. The method for printing and authenticating a marking according to claim 4 for which all or part of the generation secret key is extracted from encrypted data contained in the two-dimensional matrix code of a printed marking.

13. The method for printing and authenticating a marking according to claim 4, wherein all or part of the generation secret key is known to a reader used for implementing an authentication method, and wherein the method comprises a step of downloading, by the reader, all or part of the generation secret key.

14. The method for printing and authenticating a marking according to claim 6, wherein the mathematical model representative of the predetermined printing conditions, implemented in the reading step, calculates a printing quality of a printer of the selected printer model at a selected printing resolution.

15. The method for printing and authenticating a marking according to claim 4, for which the control phase of the marking is implemented by a smartphone.
